(19) United States
(12) Patent Application Publication
(10) Pub. No.: US 2008/0221807 A1
(43) Pub. Date: Sep. 11, 2008

(54) PRESSURE MONITORING SYSTEM

(76) Inventors: Kevin D. Dix, Seabrook, TX (US); David Elston Brown, Lockport, NY (US); Christopher A. Lauff, McDonald, PA (US); Fang Huang Tu, Lansdale, PA (US); M. Mushtaq Ahmed, Pittsford, NY (US); Steven James Borkman, Clarence, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 12/040,974

(22) Filed: Mar. 3, 2008

Related U.S. Application Data
(60) Provisional application No. 60/906,015, filed on Mar. 9, 2007.

(51) Int. Cl. G06F 19/00; G08B 25/10

(52) U.S. Cl. 702/36; 340/614; 702/55

(57) ABSTRACT

Monitoring pressurized fluid containers through use of a container site subsystem and a system hub. The container site subsystem including sensor(s) to sense a characteristic associated with a pressurized fluid container; and a container site hub to receive, from each sensor, raw data corresponding to the sensed characteristic. The system hub receives the aggregated raw data from the container site hub, and converts the raw data to process values.

### RELATED APPLICATIONS

This application claims the benefit of U.S. Provisional Application Ser. No. 60/906,015, filed Mar. 9, 2007, which is incorporated herein by reference. This application is related to U.S. Patent Application Serial No. (21705), filed on an even date herewith, and U.S. Patent Application Serial No. (21706), filed on an even date herewith, both of which are incorporated herein by reference.

### FIELD OF THE INVENTION

Embodiments of the invention disclosed herein relate to computer-operated networks of sensors for monitoring characteristics of systems. More specifically, some embodiments relate to networks of sensors for monitoring fluid pressure in systems of pressurized fluid containers.

### BACKGROUND OF THE INVENTION

Current practice for monitoring the pressure of pressurized fluid containers or cylinders is by manual visual inspection. Often in large installations, the inspector fails to inspect every container and one or more containers can run out of fluid or the system may suffer some other compromise. The consequence and costs for these run-outs or other compromises can be significant, since these fluids often supply instruments critical to a process or are required by regulations. Additionally, for large installations, the time required to inspect 100-1000 containers can be significant.

Thus an improved solution is needed to monitor each end-point cylinder to reduce the likelihood of run-outs or other system compromises, and lower the amount of costly downtime. One solution is to employ pressure transducers or in a wired network to measure the cylinder pressure at the sensor. However this has the drawback of numerous wire connections when multiple end-point cylinders need to be monitored. Also it does not provide a visual indication of pressure without additional components. It is also know to use pressure switches that activate at a pressure threshold, but do not provide process value readings.

### BRIEF SUMMARY OF THE INVENTION

Embodiments of the invention include a system for monitoring pressurized fluid, e.g., in containers including pipelines. The system includes at least one container site subsystem with at least one sensor, a container site hub, and a system hub. The sensor is operative to sense a characteristic associated with a pressurized fluid container. The container site hub receives raw data from each sensor corresponding to the sensed characteristic. The system hub receives aggregated raw data from each container site hub, and converts the raw data to process values.

Further embodiments include at least one router/repeater, topologically positioned between sensors and the co-sited container site hub. The router/repeater relays the raw data from each associated sensor to the container site hub.

In some embodiments, at least one sensor is a wireless pressure sensor, and communications between at least one container site subsystem and the system hub is point-to-point.

Embodiments of invention act upon the occurrence of an event where the action includes alert a user, request re-supply of pressurized fluid (in some cases in based on usage rate and resupply lead times), and request maintenance. Events include a sensed characteristic falling outside a range of values, a sensed characteristic falling outside a set of states, a rate of change of a sensed characteristic falling outside a range of values, and a trend suggesting a requirement for system maintenance is detected.

The technology includes methods for monitoring pressurized fluid containers at a site, with steps at containers, sensors, router/repeaters, container site hubs, and the system hub. At sensors associated with pressurized fluid containers a characteristic associated with the container is sensed. At a container site hub, raw data corresponding to the sensed characteristic is received from at least one pressurized fluid container at the site. In some embodiments, raw data is relayed from the sensors through at least one router/repeater to the container site hub. The container site hub aggregates the received raw data for a subset of the containers at the site; and sends it to the system hub. At the system hub, the aggregated raw data is received from at least one container site hub, and converted to one or more process values.

In some embodiments, the method includes receiving the raw data from at least one sensor at the container site hub via a wireless link. Further variations include receiving aggregate data at the system hub via a point-to-point communications link.

Embodiments of the invention act under the direction of a computer program product upon the occurrence of an event. The actions available include: alerting a user, requesting resupply of pressurized fluid (in some cases in based on usage rate and resupply lead times); and requesting maintenance of at least one of the system and the pressurized fluid system. Events that trigger such action include: a sensed characteristic falling outside a range of values, a sensed characteristic falling outside a set of states; a rate of change of a sensed characteristic falling outside a range of values; and a trend suggesting a requirement for system maintenance is detected.

### BRIEF DESCRIPTION OF THE SEVERAL VIEWS OF THE DRAWING

Other objects, features, and advantages of the present invention will become more apparent from the following detailed description of the preferred embodiment and certain modifications thereof when taken together with the accompanying drawings in which:

FIG. 1 illustrates a pressurized fluid monitoring system of the present invention.

FIG. 2 illustrates a container site subsystem of the present invention.

FIG. 3 illustrates pressure gauge installation with respect to a pressurized fluid cylinder.

FIG. 4 illustrates a wireless pressure gauge of the present invention.

FIG. 5 illustrates a system hub of the present invention.

### DETAILED DESCRIPTION OF THE INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention. While best mode is described, not all embodiments contain all features described herein. “Subset,” as used herein, includes the full set and the empty set in addition to proper subsets. The individual features described herein relate to an exemplary composite of various embodiments of the invention.

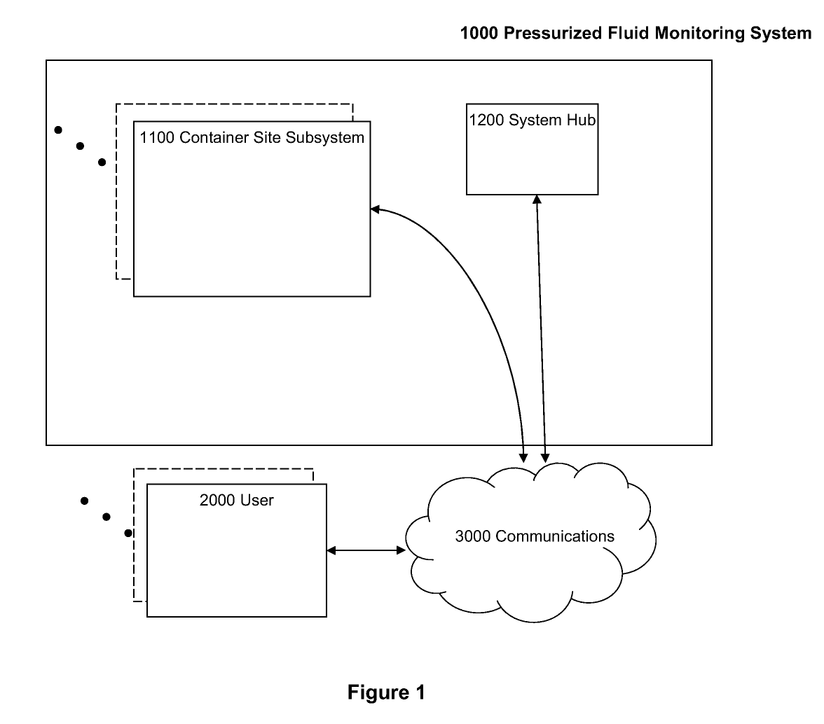

Referring to FIG. 1, in some embodiments, a pressurized fluid monitoring system 1000 comprises at least one container site subsystem 1100 and a system hub 1200. A single system hub 1200 can serve multiple container site subsystems 1100 and multiple users 2000 over communications 3000.

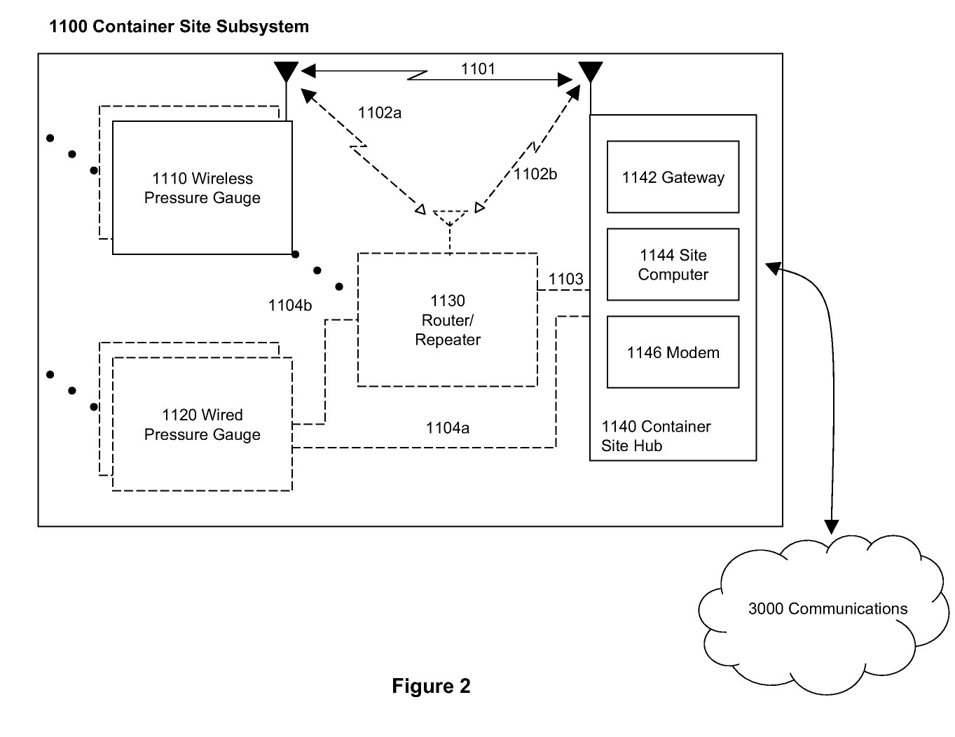

Referring to FIG. 2, a container site subsystem 1100 includes at least one pressure gauge 1110, 1120 in communication with a container site hub 1140. The container site subsystem 1100 optionally can include optionally one or more router(s)/repeater(s) 1130, e.g., to extend the range of the subsystem.

The communication path between the wireless pressure gauge 1100 and the container site hub 1140 is a direct wireless communication path 1101 in some embodiments of the invention, but may also be a wireless path 1102a, 1102b through a router/repeater 1130, or partially wireless as in path 1102a, 1103 through a router/repeater 1130 wired via path 1103 to the container site hub 1140.

Embodiments of the invention employ pressure gauges that provide a visual indication of pressure in a container.

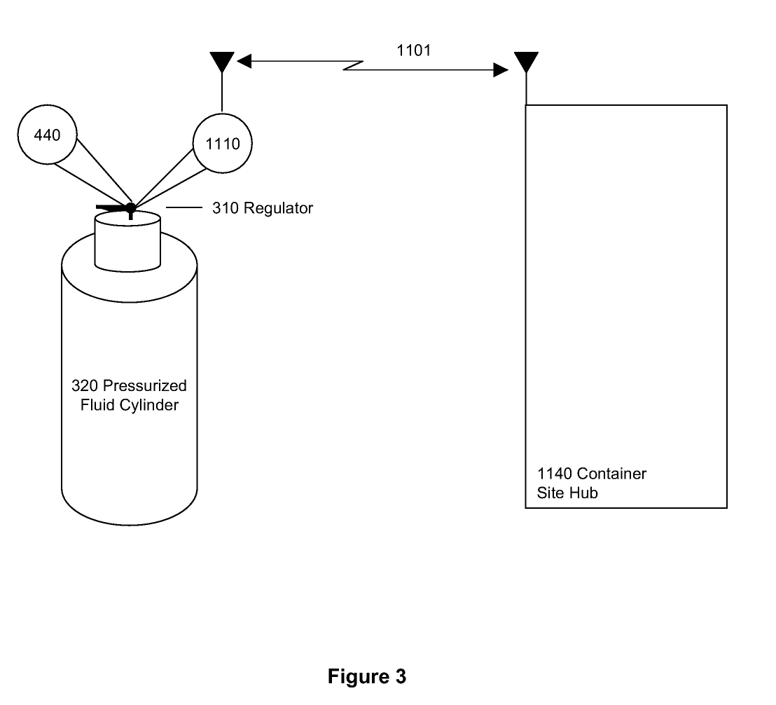

Preferred embodiments of the invention include pressure gauges with built-in wireless communication capabilities to transmit a signal (preferably a digital signal) related to the pressure in a container. The signal, in many embodiments, is a raw transducer value and requires further processing to yield a process value (fluid pressure). As shown in FIG. 3, in some embodiments, the wireless pressure gauge 1110 is installed on an upstream side of a cylinder pressure regulator 310 that is mounted on a pressurized fluid cylinder 320. A preferred gauge 1110 includes electronic circuitry to function as a transceiver, and can periodically (e.g., every 15 minutes) transmit information, preferably in the form of digital signals, relating to fluid system parameters, e.g., fluid pressure in the cylinder, battery voltage, ambient temperature, cylinder temperature. The gauge 1110 can also receive configuration information (e.g., timing of readings and communication with the container site hub 1140, duration of readings) from a container site hub 1140. The gauge 1100 can enter a power-save mode when not transmitting data and after making any changes, such as timing of communication with the container site hub 1140, per instructions in the configuration information received. The technology of the invention, not requiring a dedicated data storage collar or docking station for each cylinder, provides more reliable pressurized fluid supply management and reduces labor and costs associated with site patrols for checking pressurized fluid cylinders when compared to other approaches.

Wireless pressure gauges 1110 can be gathered into node groups. Different node groups can be monitored by different users at the customer site. Each user can be given access to any number of node groups and will then receive alert e-mails for the gauges in those groups.

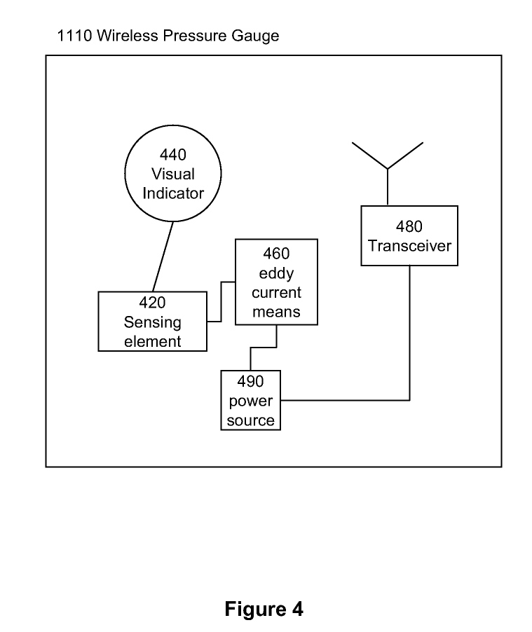

Referring to FIG. 4, the wireless pressure gauge 1110 such as that described in U.S. Pat. No. 7,140,257 comprises a bourdon tube pressure sensing element 420, a visual indicator 440 to display fluid pressure sensed by bourdon tube pressure sensing element, means 460 to generate eddy current corresponding to fluid pressure and convert the electrical signal of the eddy current into a digital signal, a radio transceiver unit 480 to transmit and receive wireless digital signals, and a power source 490 such as a battery.

Referring again to FIG. 2, in some embodiments, the container site subsystem 1100 includes one or more wired pressure gauges 1120 employing wired communications, e.g., as in the case where existing gauges and wiring provide acceptable performance and are advantageous from a cost and schedule perspective over installation, maintenance, and operation of wireless gauges 1110. As with wireless pressure gauges 1110, the communications path between a wired pressure gauge 1120 and the container site hub 1140 can be direct, e.g., path 1104a, or relayed through a router/repeater 1130, e.g., path 1104b, 1103 or path 1104b, 1102b.

An optional router/repeater 1130 serves as a range extender and network expander to transmit signals between one or more pressure gauges and the container site hub 1140. The transmissions could go though one or more routers/repeaters 1130 in series in a network. This way the span of the network can be extended, e.g., to thousands of feet and many pressure gauges. For example, each wireless router/repeater 1130 can communicate wirelessly up to 100 ft. or more (depending on physical obstacles) to a container site hub 1140 or another router/repeater 1130, and 60 ft. or more to one or more wireless pressure gauges 1100. Several router/repeaters 1130 can be connected to a single container site hub 1140, either in series or in parallel.

The container site hub 1140 receives information, in some embodiments via one or more router/repeaters 1130 sent by one or more pressure gauges 1110, 1120, stores the received information for transmission (e.g., periodic transmission), aggregates the raw data, and transmits the information to the system hub 1200 via communications 3000 (e.g., modem to modem via dial-up telephone call using a wired connection, packet transfer over a wireless connection, Ethernet, Internet, and other various communications channels known to those skilled in the art of the invention). The container site hub 1140 receives container site subsystem 1100 configuration information and/or software updates from the system hub 1200 via the communications 3000 and sends that information to the appropriate elements (e.g., gauges 1110, 1120 and router/repeaters 1130).

In some embodiments, the container site hub 1140 comprises at least one gateway 1142 that serves as a transceiver, and at least one container site computer 1144, and a container site modem 1146. In some embodiments, the gateway 1142 is connected to the container site computer 1144 via a simple serial interface such as RS-232. In some embodiments, the container site hub 1140 receives the digital signals (readings) from the pressure gauges, temporarily stores the readings in a container site computer, and sends the readings via a point-to-point communication link such as modem-to-modem telephone call to the system hub 1200.

The container site hub 1140 allows control of downstream gauges and routers using the gateway 1142. The gateway 1142 aggregates data traffic from wireless pressure gauges 1100 and routers 1130 within radio range, and communicates to the container site computer 1144. The gateway 1142 also relays commands from the container site computer 1144 to routers and to the radio transmission unit 480 in wireless pressure gauges. Other sensors, e.g., a data acquisition board, may be incorporated into the system via interfaces, e.g., a Universal Serial Bus (USB) port, at the container site hub 1140.

The container site computer 1144 serves as the host computer of each gateway 1142. This container site computer 1144 locally stores the digital signals received from the pressure gauges 1110, 1120 via a gateway 1142. The container site computer 1144 is also capable of storing data, for example, up to ten (10) days of readings for each pressure gauge 1100. This way data is not lost if there is a problem establishing successful communications with system hub 1200. Table 1 lists example container site subsystem 1100 example specifications. The North American area classification principles are stated in article 500 and 505 of the National Electrical Code (NEC), formally identified as ANSI NFPA 70. System wireless gauges 1110 are classified for use in Class I Div II Group A, B, C, D environments. In some embodiments, router/repeaters 1130, gateway 1142 and container site computers 1144 are not rated to be used in a classified area.

A container site modem 1146 provides an interface to communications 3000 in some embodiments.

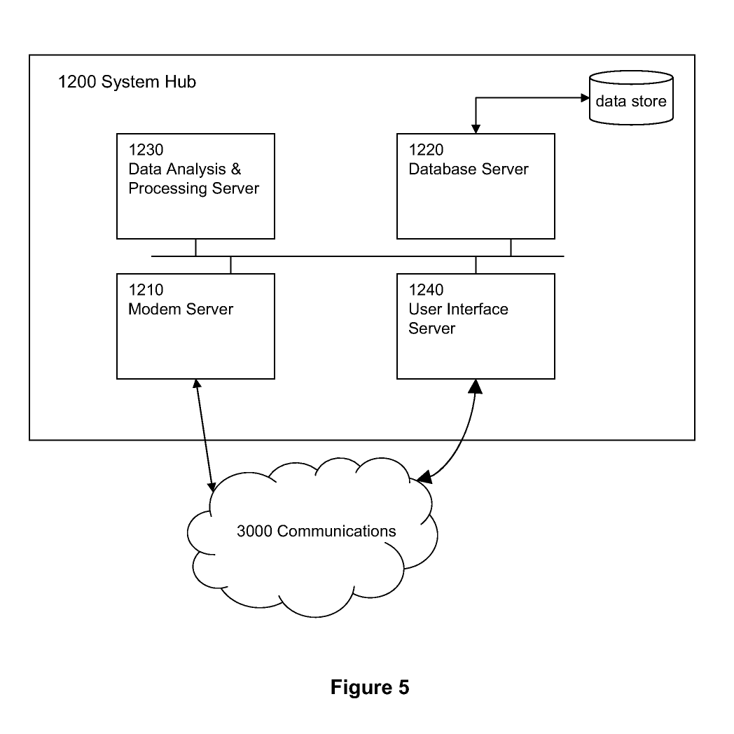

Referring to FIGS. 1 and 5 the system hub 1200 comprises a modem server 1210, database server 1220, data analysis program 1230, and user interface server 1240. The system hub 1200 communicates with one or more container site hubs 1140, as well as converts digital signals relating to fluid system characteristics (e.g., pressure, temperature) received from the container site hub 1140 into process values (e.g., pressure, temperature). Once measurements relating to the contents of each cylinder is acquired by way of a container site subsystem 1100, this information can be used to place orders for replacement cylinders as well as be utilized to provide other services such as usage information, expiration date, certificates of analysis, composition, and other information to the user. In some embodiments, the system hub will be located at facilities of a pressurized fluid supplier.

TABLE 1
Example Container Site Subsystem

Router and Gateway Specifications
1) Direct Sequence Spread-Spectrum
2) Center frequency 916 MHz ISM band
3) Transmit power 0 dBm Maximum EIRP
4) Receive sensitivity −85 dBm Typical
5) Range to router or gateway 100 ft (typical indoor environment,
line of sight)
6) Range to endpoint 60 ft (typical indoor environment, line of sight)
7) Data rate 115 kbps Maximum
8) RS-232 Interface
9) Router Data rate 9.6 kbps
10) Gateway Data rate 115 kbps
11) AC power, 100-240 VAC 50/60 Hz 0.3 A
12) Operating temperature −40 to +85° C.
Container site computer
1) Closed computer system, not accessible by the customers
2) Analog phone line is needed for data transmission
3) Non-Classified, Install at general service area only.
4) AC power, 115 V 50/60 Hz
5) Default parameters:
a. Data storage: 1000 data point per gauge
b. Pressure data reading: every 15 minutes
c. Upload data interval: every four (4) hours

The system hub 1200 includes a computer system that receives digital signals from the container site subsystem 1100 through a point-to-point connection, and converts digital signals (readings) from the container into pressure values. This computer system has additional functionalities implementing process and business logic such as data storage, analysis, trending, alarming, generating configuration information (e.g., sampling period, network topology) for the pressure gauges 1110, 1120, router/repeaters 1130, and container site hub 1140, and providing access to user of the system 1000, e.g., through a user interface server 1240 such as a web server. These functionalities could be hosted on a single platform, or distributed across multiple platforms.

The modem server 1210 serves as the interface between container site computers 1144 and other computers and/or programs in system hub 1200. From time to time (including periodically and on-demand), the container site computer 1144 establishes a point-to-point connection via communication 3000 (for example a modem-to-modem phone call) with a modem in the system hub 1200 modem server 1210. In preferred embodiments, this point-to-point connection uses a simple protocol to send data to the system hub 1200, receive sensor configuration data (e.g., sampling interval), and software updates. Configuration data is then transmitted to the container site subsystem 1100 elements such as router/repeaters 1130 and gauges 1110, 1120. In certain embodiments, this protocol does not give the container site computer 1144 access to the system hub 1200 internal network and does not involve networking protocols such as Serial Line Internet Protocol (SLIP), Point-to-Point Protocol (PPP), Transmission Control Protocol (TCP), Internetwork Packet Exchange (IPX), or Internet Protocol (IP). The protocol employed uses a tailored data-link layer to address data integrity, and to mitigate the risk that packets are delivered to the application out of order. There is no network layer (as defined by OSI) in this protocol as connections are point-to-point. The communications 3000 between the container site computer 1144 and the system hub 1200 modem server 1210 are established on a user-configurable schedule, e.g., every four (4) hours, on demand.

The data received from the container site is stored in a database server 1220 that may reside on the same computer as the modem server 1210 or, e.g., a different computer connected by a private local area network to the modem server 1210.

The data analysis program 1230 can also perform range checking on raw and converted values, generate alerts based on preset or user set threshold and predict when a user action is needed based on stored data. The data received by the modem server 1210 from the container site subsystem 1100 is converted into process values (pressure). The raw data, as well as converted data, are stored in a database server 1220.

The pressure gauges 1110, 1120 provide pressure readings as a visual indication, for example on a dial, as well as transmits digital signals that are converted into pressure values by a the data analysis program 1230 in the system hub 1200. Without a conversion program (algorithm, logic) the digital signals do not yield pressure values.

The data analysis program 1230, residing e.g., on the same platform as the modem server 1210, database server 1220, or on a different computer, converts the customer site readings relating to pressure into pressure values, and these values may be stored in the database server 1220. The data analysis program 1230 can also perform diagnostics on measurements such as range checking, generate alerts based on preset or user set threshold, and predict when a user action, e.g., reordering, container maintenance, is needed based on stored data. On the basis of the data analysis, alert notices are sent to end users regarding the status of the wireless monitoring system via web pages, emails, pagers and/or cell phone text messages. Where user action is required, the user will also be told what actions are needed via the methods above.

For example the data analysis program will: predict when a parameter data will reach a threshold level/status; predict when a user action is required; initiate activities with other systems (e.g., ordering system, service system); determine whether a parameter threshold has been reached; determine the rate of parameter change; determine whether there is an abnormal usage pattern; diagnose wireless pressure monitoring system 1000 operational and/or performance problems; determine whether a wireless gauge 1110 has lost communication with a container site computer 1144; determine whether a container site computer 1144 has lost communication with the modem server 1210; and determine whether any of the other wireless devices (e.g. router/repeaters 1130) have lost communication with a container site computer 1144; and determine whether a battery 490 needs to be replaced.

The user interface server 1240 may be a web server residing on a separate computer or one of the servers mentioned above. The web server allows the end user to access current and historical information via the World Wide Web. Web pages generated by the web server display current parameter measurements (e.g., process values), alerts, abnormal usage pattern, reminders of any necessary actions and other information related to data gathered by network sensors such as gauges 1110, 1120.

The system enables a user to access this information from any location with an Internet connection, and can choose from three different levels of services. While a web server is described, embodiments of the invention include a user interface that employs various means of communication 3000 to include cellular telephone, pager, short message service (SMS) device, voice mail, and e-mail.

Communications 3000 can be multimode. For example, a single path between the system hub 1200 and any user 2000 can be multimode and include, e.g., the Internet and cellular telephone networks. Further, communications 3000 for a first path can be in a first mode(s) (e.g., between system hub 1200 and user 2000 multimode as described above), while other paths can be single mode (e.g., between system hub 1200 to a first container site subsystem 1100 via the Public Switched Telephone Network (PSTN)). In some embodiments, the communication 3000 between the system hub 1200 and container site subsystem 1100 can be characterized as “point-to-point” transmission (“Alliance for Telecommunications Industry Solutions (ATIS) Telecon Glossary 2000 (T1.523-2001)” defines point-to-point transmission as communications between two designated stations only).

The pressure gauge 1110, 1120 digital signals (readings) transmission interval and container site hub 1140 upload interval are practically infinitely adjustable, but typically ranges from minutes to hours. The sample interval at a gauge 1110, 1120 and upload interval could be changed by the users, the system administrator, and the data analysis program. For example, if an abnormal pattern is detected by the data analysis program, a shorter sample and upload interval will be set for more frequent monitoring in order to better determine when a user action is required or a service call is needed.

The monitoring system is applicable to any system that employs a sensor (for example flow meter, temperature, composition, level), with particular applicability to sensors that generate a digital signal that will be converted at a system hub 1200 into process value. The unprocessed data could be current, voltage, serial data and/or digital numbers.

The monitoring system could extend the coverage to a place where installation of a wired monitoring system is not practical. Data processing and analysis programs of the system diagnose and predict system status more efficiently and effectively compared to embedding such capabilities at the sensor level. The system provides remote data access capability and remote service functions to end users, thus replacing some manual user actions and requests.

For systems of wireless gauges 1110, installation cost and operations cost are reduced compared to wired sensor installation. Automated service functionalities provide better customer service to reduce downtime and run-outs due to mismanagement and/or human errors.

Embodiments of the system enable a user to access system information from any location with an Internet connection.

Embodiments of the system provide at least three levels of service to a user. Silver Service is for customers who want to monitor their pressurized fluid usage. It is suitable for environments where pressurized fluid are used at consistent or inconsistent rates. Silver Service gives customers the flexibility to set their own alarm levels and to manage their pressurized fluid supplies. With Silver Service, a user can: view current pressure readings via a website (pressure readings are updated, e.g., every 4 hours); access pressure graphs with historic, e.g., up to one year of data; customize pressure level thresholds (lower, upper, and critical/warning levels); choose to receive alerts via e-mail when pressures exceed threshold limits.

Gold Service is designed for users who want to further facilitate their pressurized fluid cylinder management process. With Gold Service, a user can, in addition to functionality available with Silver Service: receive notifications when to place orders based on their pressurized fluid usage rate and known product delivery lead times; place orders on the website.

Platinum Service users have access to Gold Service functionality and orders for cylinders are placed automatically by the system. With Platinum Service, cylinders arrive at the customer's location when needed without substantial customer intervention.

The above-described technology can be implemented on hardware including various computing devices, such as a personal computer, Personal Digital Assistant (PDA), internet enabled telephone, dedicated fluid pressure monitor device, or the like, or on/across separate programmed general purpose computer(s). Additionally, the systems and methods of this invention can be implemented on a special purpose computer, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing a state machine that is in turn capable of implementing the processes described herein can be used to implement the systems and techniques according to this invention.

While the embodiments illustrated herein show the various components of the system co-located, it is to be appreciated that the various components of the system can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. For example, the invention can be embodied in alternate forms where functions of elements such as the router(s), gateways(s), and computers are implemented on a single computing platform, or distributed across multiple platforms; and in various languages, operating systems, and IT protocols. As will be appreciated from the accompanying description, and for reasons of computational efficiency, the components of the system can be arranged at any location within a distributed network without affecting the operation of the system. Moreover, components could be embedded in dedicated fluid pressure monitoring machines.

Furthermore, it should be appreciated that the various links, including the channel, connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

Furthermore, the disclosed methods may readily be implemented in software using object or object-oriented software development environments that provide portable source code that can be used on a variety of computer or workstation platforms. Alternatively, the disclosed system may be implemented partially or fully in hardware using standard logic circuits or, for example, a VLSI design. Whether software or hardware is used to implement the systems in accordance with this invention is dependent on the speed and/or efficiency requirements of the system, particular function, and the particular software or hardware systems or microprocessor or microcomputer systems being utilized. The systems and methods illustrated herein can be readily implemented in hardware and/or software using any suitable systems or structures, devices and/or software, such as JAVA®, by those of ordinary skill in the applicable art from the functional description provided herein and with a basic general knowledge of the computer and data or image processing arts.

Moreover, the disclosed methods may be readily implemented in software, e.g., as a computer program product, executed on a programmed general purpose computer, a special purpose computer, a microprocessor, or the like. In these instances, the systems and methods of this invention can be implemented as a program embedded on a personal computer such as a JAVA®, CGI or Perl script, as a resource residing on a server or graphics workstation, as a routine embedded in a dedicated image system, or the like. The systems and methods of this invention can also be implemented by physically incorporating this system and method into a software and/or hardware system, such as the hardware and software systems of a computer. Such computer program products and systems can be distributed and employ a client-server architecture. While exemplary embodiments disclosed herein use still imagery to enable principles of the invention, these principles can also be applied to, e.g., video, medical imaging, transmission of images to wireless devices.

We claim:

1. A system for monitoring pressurized fluid containers, the system comprising:
at least one container site subsystem, comprising
at least one sensor, operative to sense a characteristic associated with a pressurized fluid container;
a container site hub;
in communication with each sensor, and
operative to:
receive, from each sensor, raw data corresponding to the sensed characteristic, and
aggregate the received raw data for a subset of the containers at the site; and
a system hub;
in communication with the container site hub, and
operative to:
receive the aggregated raw data from the container site hub, and
convert the raw data to process values.

2. The system of claim 1, wherein the container site subsystem further comprises:
at least one router/repeater,
topologically positioned between at least one remote sensor associated with the router/repeater and the container site hub, and
operative to relay the raw data from each associated sensor to the container site hub.

3. The system of claim 1, wherein:
at least one sensor is a wireless pressure sensor.

4. The system of claim 1, wherein:
communications between at least one container site subsystem and the system hub is point-to-point.

5. The system of claim 1, wherein:
the system is further operative to act upon the occurrence of an event, and the action comprises at least one of:
alert a user,
request resupply of pressurized fluid;
request maintenance of at least one of the system and the pressurized fluid system.

6. The system of claim 5, wherein:
the event comprises at least one of:
a sensed characteristic falling outside a range of values,
a sensed characteristic falling outside a set of states;
a rate of change of a sensed characteristic falling outside a range of values;
a trend suggesting a requirement for system maintenance is detected.

7. A method for monitoring pressurized fluid containers at a site, the method comprising:
at each of one or more pressurized fluid containers at the site, sensing a characteristic associated with the container;
at a container site hub,
receiving raw data corresponding to the sensed characteristic from at least one pressurized fluid container at the site, and
aggregating the received raw data for a subset of the containers at the site; and
at a system hub, receiving the aggregated raw data from at least one container site hub, and
converting the raw data to one or more process values.

8. The method of claim 7, wherein, intermediate to sensing a characteristic and receiving raw data, the method further comprises:
relaying the raw data from at least one sensor through at least one router/repeater to the container site hub.

9. The method of claim 7, wherein:
receiving the raw data from at least one sensor at the container site hub is via a wireless link.

10. The method of claim 7, wherein:
receiving aggregate data is via a point-to-point communications link.

11. The method of claim 7, further comprising:
at the system hub implemented at least in part on a computer:
acting under the direction of a computer program product upon the occurrence of an event, where the action comprises at least one of:
alerting a user,
requesting resupply of pressurized fluid;
requesting maintenance of at least one of the system and the pressurized fluid system.

12. The method of claim 11, wherein:
the event comprises at least one of:
a sensed characteristic falling outside a range of values,
a sensed characteristic falling outside a set of states;
a rate of change of a sensed characteristic falling outside a range of values; and
a trend suggesting a requirement for system maintenance is detected.
